(19) United States
(12) Patent Application Publication
(10) Pub. No.: US 2011/0196268 A1
(43) Pub. Date: Aug. 11, 2011

(54) Precision Guidance of Extracorporeal Shock Waves

(76) Inventors: Robert C. Smith, Rockville, MD (US); William J. Davros, Shaker Heights, OH (US); Jeffrey D. Neitlich, Miami Beach, FL (US)

(21) Appl. No.: 12/905,827

(22) Filed: Oct. 15, 2010

Related U.S. Application Data
(60) Provisional application No. 61/252,098, filed on Oct. 15, 2009.

(51) Int. Cl. A61H 1/00

(52) U.S. Cl. 601/4

(57) ABSTRACT

Described herein are apparatus for performing lithotripsy. The apparatus comprise a CT scanner and a shock wave tube for generating shock wave pulses for fragmenting kidney stones. The CT scanner includes a guidance system which is utilized to guide and control the position of the shock wave tube relative to a patient. The shock tube moves along an track which may be coupled to the CT scanner or which may be movable relative to the scanner. The track may be circular or semi-circular. The shock tube is movable about three orthogonal axes, which movement is controlled by the guidance system. A method for performing the lithotripsy using the apparatus is also described herein.

### CROSS REFERENCE TO RELATED APPLICATIONS

This application claims the benefit of U.S. provisional patent application No. 61/252,098, filed Oct. 15, 2009, the entire disclosure of which is hereby incorporated by reference.

### BACKGROUND

Kidney stones are a common problem affecting about 10-12% of the United States population. As long as stones remain intact within the kidney, they may cause few, if any, symptoms. However, when stones become dislodged and pass into the ureter, they can block the ureter resulting in severe pain, usually referred to as renal colic. Estimates suggest that up to 5% of women and 12% of men living in the United States will suffer at least one episode of renal colic during their lifetime. Of that 12%, more than 1.2 million will require treatment for kidney stones each year. Moreover, renal colic tends to recur, with a recurrence rate of about 50% within the first five years after a first attack and about 75% over the patient's lifetime.

As a result, a number of methods can be used to treat symptomatic kidney stones. Extracorporeal Shock Wave Lithotripsy (ESWL) has gained widespread acceptance since first introduced in 1980 and is currently the treatment of choice for most kidney stones. Lithotripsy machines have four main features: an energy source, known as a shock tube, to generate shock waves; a mechanism for focusing the shock waves; a coupling medium to couple the shock waves to the patient; and a stone localization system. A lithotripter fragments stones by generating shock waves that are focused at the location of the stone. The shock waves are high amplitude, low-frequency pressure waves that can be generated in a gas or liquid medium. The shock waves exhibit little damping effect, because they are of low frequency. Additionally, shock waves generated in water are transmitted unimpeded through normal body tissues, because normal body tissues have essentially the same acoustic impedance as water.

As a result, shock waves can be generated outside of the body (extracorporeally), yet still exert a significant pressure effect at a distant point within the body. When the shock waves do meet an interface that has acoustic impedance which differs from water, such as a stone, a compressive force results and causes stone fragmentation. Unfortunately, if the shock waves encounter other structures such as ribs or air-containing bowel before reaching a stone, the shock waves can be attenuated or reflected and therefore be less effective in stone fragmentation.

Early lithotripters utilized a spark gap energy generator with an elliptical reflector to focus the sound waves. The spark gap was positioned at one focus of a semi-ellipsoid reflector (F1). The shock waves were then focused at a fixed distance from F1 at the second focal point of the ellipse (F2), where the amplitude of the shock wave is greatest. During treatment, the stone was hopefully brought to the point F2. A water bath (into which the patient was placed) transmitted the shock wave from the reflector to the patient.

Modern lithotripters use an electromechanical shock wave generator where an electromagnet causes a metal membrane to vibrate and send shock waves down a water-filled tube which has an acoustic lens at the end opposite the electromagnet. The shock tubes are coupled to the patient using a gel. A water bath is therefore no longer required. Stone localization is accomplished using either fluoroscopy or diagnostic ultrasound. Whichever method of localization is utilized, stone fragmentation requires the sequential application of thousands of shock waves over a period of about 60 minutes.

A fluoroscope is a machine having an X-ray source and an X-ray detector. The fluoroscope generates two-dimensional images for display on a TV screen or monitor. The X-ray source and detector are typically mounted on opposite sides of a rotating C-arm. At rest, the source is oriented along the axis of the shock tube. By rotating the C-arm and obtaining images at several angles, the location of the stone is estimated. Fluoroscopy however is a primitive method of visualizing kidney stones as it relies on the calcium content of stones to attenuate the X-ray beam through photoelectric interactions. Fluoroscopy will at best be able to visualize approximately 60% of all stones. Small stones and stones which do not contain sufficient calcium, for example, uric acid stones, will not be visible using fluoroscopy.

As an alternative to fluoroscopy, some lithotripsy machines rely on diagnostic ultrasound for stone localization. These machines place a diagnostic ultrasound transducer along the line of transmission of the shock waves to determine the depth of the stone. However, only stones within the kidney can be visualized using diagnostic ultrasound. Whether using a fluoroscope or ultrasound for stone localization, monitoring response to therapy is difficult because resulting stone fragments are small and even more difficult to visualize than the original stone.

The presently used methods of visualizing and treating kidney stones have a high rate of misdiagnosis, cannot accurately visualize stones and stone fragments, and as a result are not an effective enough avenue for treatment.

### SUMMARY

Described herein is an apparatus for performing lithotripsy. In one example embodiment, the apparatus has an improved guidance system for a shock tube used to generate shock waves for fragmenting kidney stones. The shock tubes themselves can have reduced energy requirements allowing the use of a smaller shock tube. Generally, the apparatus described herein can reduce the number of shock waves required to fragment stones and thereby reduce the overall time for fragmentation. Further described herein are methods for performing lithotripsy using the apparatus described.

In one example embodiment, the apparatus comprises a shock wave tube for generating shock wave pulses for fragmenting a kidney stone and a CT scanner including a computer for guiding the shock wave tube and hence the shock wave pulses. The computer determines the location of a kidney stone to be treated and obtains a volume rendering to determine the relationship between the kidney stone and surrounding tissues and/or structures. The computer uses volume rendering to determine a shock wave path including an entry site on the patient, and for controlling movement of the shock tube. In another example embodiment, the shock tube moves along an arcuate track, which may be physically coupled to the CT scanner or which may be movable relative to the CT scanner. The track may be semi-circular or circular. The shock tube is further movable about three axes of orientation. The shock tube is positioned along the track and relative to the patient via the computer.

In another example embodiment, the apparatus described herein comprises a removable plastic cap fitted over the shock wave tube. The plastic cap further comprises a rod extending from the plastic cap along an axis of the shock wave tube. The rod itself has no x-ray attenuation. At the end of the rod is a sphere of radiopaque material, preferably an epoxy, but can be any radiopaque material known in the art. The sphere can be small, with a diameter less than about 1.0 mm. The rod has a length such that the sphere at its tip is positioned at the maximal focal point of the shock wave tube.

In one example embodiment described herein are methods comprising the steps of providing a CT scanner having a table and a guidance system; placing a patient on the table; performing a volume acquisition and reconstructing images obtained from the volume acquisition to determine the location of at least one kidney stone; performing a volume rendering to determine a relationship between the at least one kidney stone and surrounding structures; using the guidance system to determine a shock wave path including an entry site on the patient from the volume rendering; using the guidance system to position a shock tube so as to generate a shock wave along the determined shock wave path; and generating at least one shock wave using the shock tube so as to fragment the at least one kidney stone.

Other details of the apparatus and methods, as well as other objects and advantages attendant thereto, are set forth in the following detailed description and the accompanying drawings in which like reference numerals depict like elements.

### BRIEF DESCRIPTION OF THE DRAWINGS

FIG. 1 illustrates a sectional view of a shock tube for generating shock waves for treating kidney stones.

FIG. 2 illustrates a sectional view taken along lines 2-2 in FIG. 1.

FIG. 3 illustrates a schematic representation of an apparatus for treating kidney stones.

FIG. 4 illustrates a sectional view of a CT scanner with a circular track and a shock tube mounted on the circular track for performing lithotripsy.

FIG. 5 illustrates a plastic cap that is fitted over a shock tube.

FIG. 6 illustrates the plastic cap of FIG. 5 fitted over a shock tube.

### DETAILED DESCRIPTION OF EXAMPLE EMBODIMENTS

Described herein are apparatus and associated methods for performing lithotripsy. The apparatus described herein include a guidance system for a shock tube used to generate shock waves for fragmenting at least one kidney stone. The shock tube itself can have reduced energy requirements, when compared to conventionally used shock tubes, allowing the use of a smaller tube. Generally, the apparatus described herein reduces the number of shock waves and overall time required to fragment stones.

The apparatus described herein generally involves the use of a shock wave tube in conjunction with a computed tomography (CT) scanner for the treatment of kidney stones. Over the past ten years, X-ray CT has become widely used for the diagnosis of kidney stones. CT uses a source of X-rays that rotates at high speed around a patient and generates an image of a slice through the body on a computer display. Conventional CT scanners generate one slice at a time with the patient remaining stationary during the X-ray exposure.

In between slices, the scanner table is advanced to the location of the next slice. CT images are unlike conventional X-ray images in that the image is a true three dimensional representation of the object scanned. Conventional X-ray images project a three dimensional object onto a two-dimensional piece of film. More recently, helical CT scanners have become available. Helical scanners operate continuously as the patient is slowly advanced through the scanner. In this manner, helical CT scanners obtain a volume of data over a short interval of time. This volume is usually divided into multiple slices for display similar to conventional CT. However, the volume of data can be stored and displayed to give a full and true three-dimensional representation of the object scanned.

CT data allows precise three-dimensional localization of objects within a patient. The location of all objects is defined with respect to the center point of the CT scanner itself. On all CT scanners, patient localization is initially determined using laser beam guidance prior to starting the scan. In addition, CT data has markedly improved contrast characteristics compared with conventional X-rays and thus allows virtually all kidney stones, to be readily identified. CT also allows evaluation of surrounding soft tissue structures, such as the kidney, muscles, bowel, liver and spleen, which are not visible on fluoroscopy, and are poorly evaluated with ultrasound. A CT of the entire abdomen can be performed in less than 30 seconds and a dedicated CT of the kidneys alone in less than 15 seconds. As such, the apparatus and methods described herein can detect and localize kidney stones in less than about 30 seconds. In other embodiments, the apparatus and methods described herein can detect and localize kidney stones in less than about one minute, or less than about 15 seconds, or less than about 10 seconds.

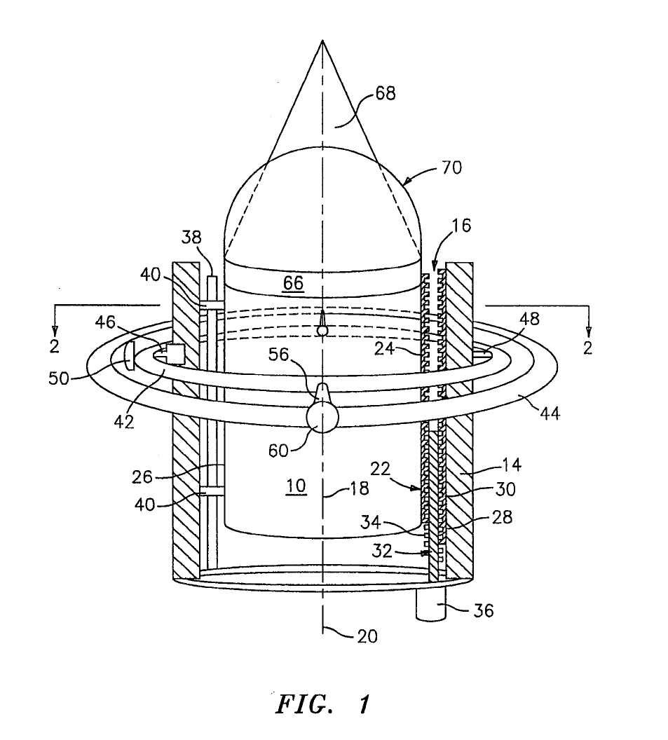

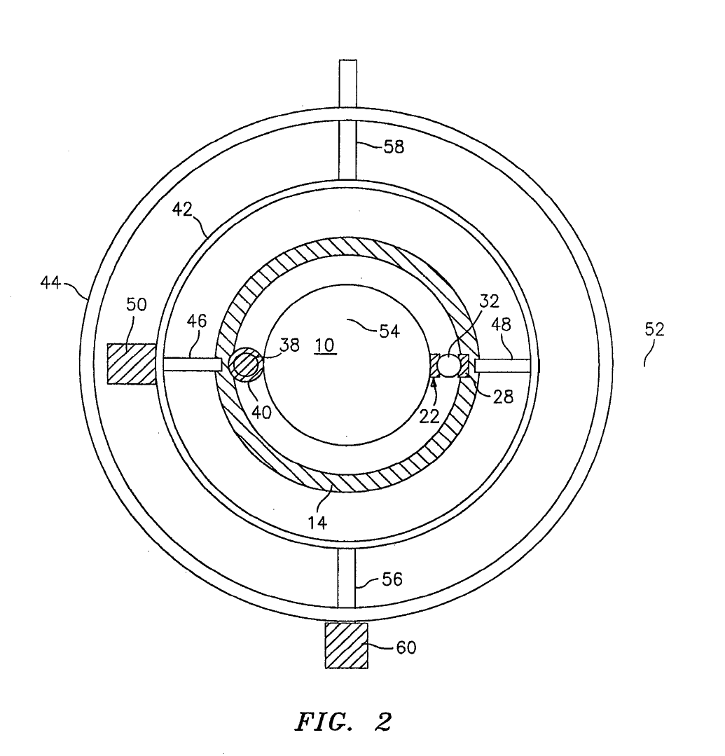

Referring now to the drawings, FIGS. 1 and 2 illustrate an example embodiment wherein shock wave tube 10 generates shock wave pulses to be used with CT scanner 12 in the treatment of kidney stones. Also illustrated is a portion of the guidance system for controlling the position of shock wave tube 10. Shock wave tube 10 may comprise any suitable shock wave tube known in the art.

In order to optimally guide shock wave tube 10, it is mounted for movement in three orthogonal directions. To this end, shock wave tube 10 is positioned within cylindrical sleeve 14. Shock wave tube 10 is joined to cylindrical sleeve 14 along one side by gearing arrangement 16 allowing shock wave tube 10 to move or translate along first axis 18 relative to cylindrical sleeve 14. In one example embodiment, first axis 18 is parallel to and coincident with central or longitudinal axis 20 of cylindrical sleeve 14. Gearing arrangement 16 may comprise any suitable gearing arrangement known in the art allowing shock wave tube 10 to translate relative to cylindrical sleeve 14. For example, gearing arrangement 16 may comprise first rod 22 having first plurality of teeth 24 joined to housing 26, second rod 28 having second plurality of teeth 30 joined to the interior of cylindrical sleeve 14, and rotatable rod 32 having helical thread 34 for mating with first plurality of teeth 24 and second plurality of teeth 30. Rotatable rod 32 may be joined to first motor 36, such as a stepper motor, controlled by the guidance system. First motor 36 causes rotatable rod 32 to rotate causing shock wave tube 10 to move relative to cylindrical sleeve 14.

In one example embodiment, cylindrical sleeve 14 can assume other shapes. For example, a sleeve can be formed as a cone, a rectangular box, a conical shape, another round shape or the like.

In another example embodiment, control rod 38 joined to the interior wall of cylindrical sleeve 14 and passing through plurality of bearings 40 joined to the housing of shock wave tube 10 helps to stabilize the translational motion of shock wave tube 10 relative to cylindrical sleeve 14. Control rod 38 may be joined to cylindrical sleeve 14 in any manner known in the art. Similarly, plurality of bearings 40 may be joined to shock wave tube 10 in any manner known in the art.

To permit movement of shock wave tube 10 about two axes, both perpendicular to axis 18, first concentric ring 42 and second concentric ring 44 are provided about the periphery of cylindrical sleeve 14. Inner ring 42 is pivotally joined to cylindrical sleeve 14 by first axially aligned axle 46 and second axially aligned axle 48. Second motor 50, such as a stepper motor, controlled by the guidance system is joined to one of first axially aligned axle 46 and second axially aligned axle 48. During operation, second motor 50 causes cylindrical sleeve 14 to pivot relative to inner ring 42 about second axis 52, substantially perpendicular to first axis 18 and axis 20 of cylindrical sleeve 14. This in turn causes shock wave tube 10 to move about a second orthogonal axis.

To allow cylindrical sleeve 14, and thus shock wave tube 10, to move about third axis 54, which is perpendicular to second axis 52 and first axis 18, outer ring 44 is pivotally joined to inner ring 42 by third axles 56 and forth axis 58. As before, one of third axles 56 and forth axis 58 is joined to a third motor 60, such as a stepper motor, controlled by the guidance system. Third motor 60 causes inner ring 42 to pivot relative to outer ring 44.

First motor 36, second motor 50 and third motor 60 are controlled by computer 64 forming the guidance system. Computer 64, as will be discussed hereinafter, determines the optimum position of shock wave tube 10 necessary for generating shock wave pulses for performing the lithotripsy or treatment of at least one kidney stone.

Referring again to FIG. 1, acoustic lens 66 is provided within shock wave tube 10 to focus shock wave 68. Acoustic lens 66 may be formed from any suitable plastic material known in the art, such as an acrylic or LUCITE® (Lucite International, Inc., Cordova, Tenn.) material. Shock wave 68 passes through flexible bellows 70 which is coupled to a patient.

Flexible bellows 70 has an adjustable length which allows the depth of placement of the shock wave focus to be variable, in addition to moving the lens in the shock tube, depending on the location of the stone. Bellows 70 provides a continuous aqueous path from the shock wave generator to a patient. An acoustic gel is placed on the end of bellows 70 and provides coupling to the skin of the patient.

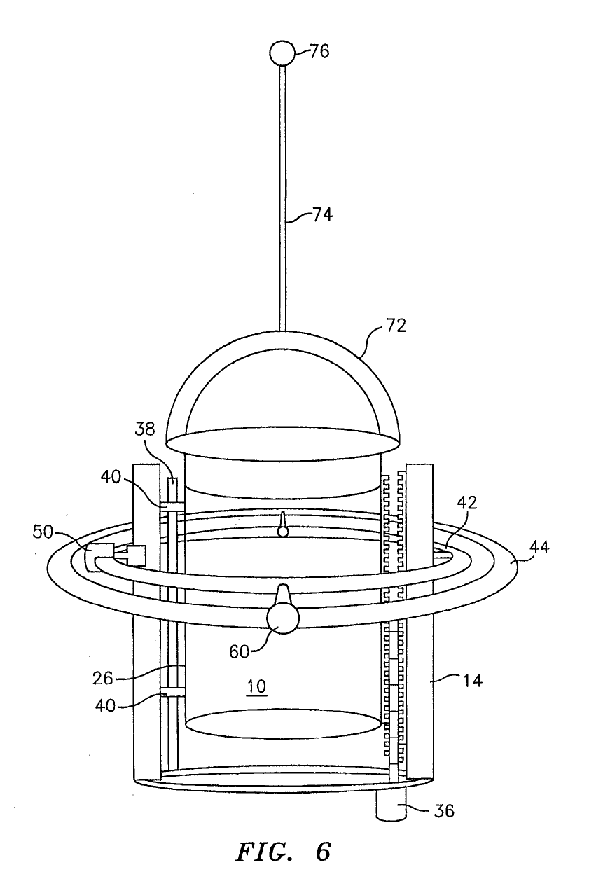

Referring to FIGS. 5 and 6, a removable precision plastic fitting, or cap 72 is fitted securely over shock wave tube 10. Plastic rod 74 extends from cap 72 along the axis of shock wave tube 10. Plastic rod 74 has substantially no x-ray attenuation. However, sphere 76 of radioopaque epoxy resin is positioned at the tip of plastic rod 74. Preferably, sphere 76 has a diameter of less than about 1.0 mm. In other example embodiments, sphere 76 has a diameter between about 0.5 mm and about 1.0 mm or between about 0.1 mm and 1.0 mm. The length of plastic rod 74 is chosen such that sphere 76 is at the maximal focal point of shock wave tube 10. Using the guidance system and laser 62 built into scanner 12, the tip of plastic rod 74 is positioned at the isocenter of the CT gantry (the reference position) and will serve as the zero point for shock wave tube 10. Positioning of the tip of plastic rod 74 may be done via computer 64 and/or a remote control (not shown). As previously discussed, computer 64 controls motion of shock wave tube 10 along first axis 18, second axis 52, and third axis 54, as well as the position of shock wave tube 10 along track 78. Once shock wave tube 10 is set, all further changes in shock tube position will be defined with respect to this reference position.

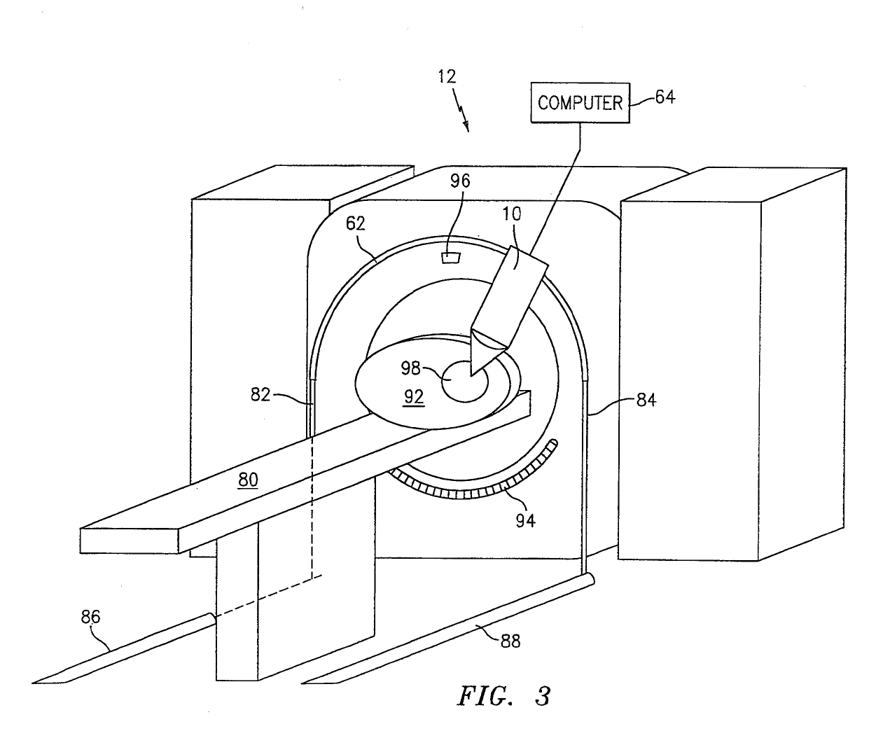

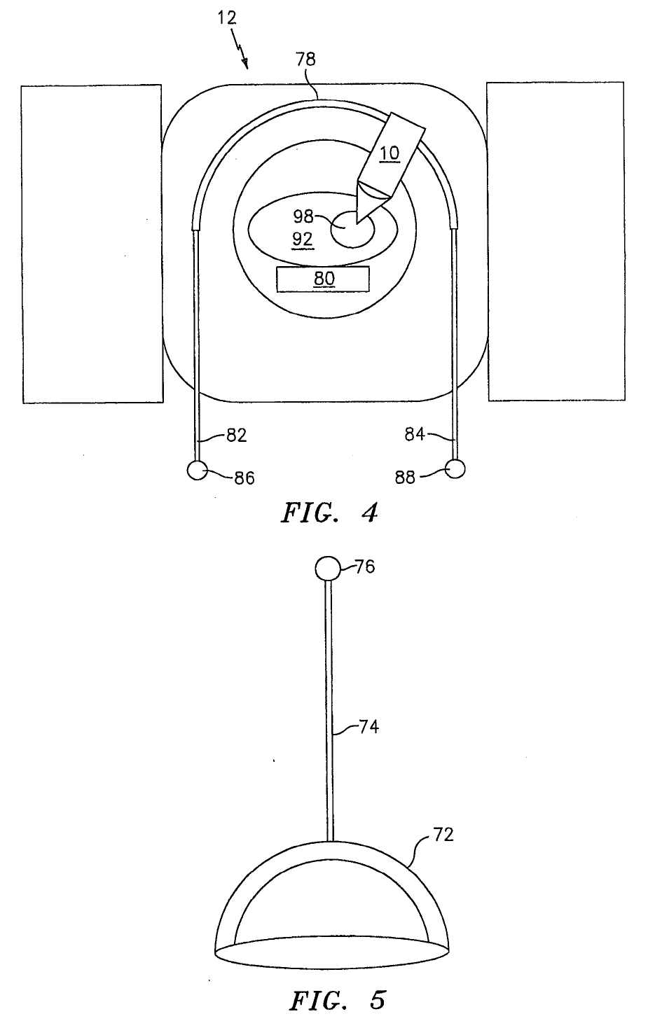

Referring now to FIGS. 3 and 4, in another example embodiment, shock wave tube 10 is used with CT scanner 12. CT scanner 12 may comprise any helical or non-helical CT scanner known in the art, such as one manufactured by General Electric, Phillips and Toshiba. As can be seen from these figures, CT scanner 12 includes table 80 which moves into and out of the scanner.

As can be seen in FIG. 4, shock wave tube 10 moves about track 78. Track 78 may be circular or semi-circular and may be mounted directly to CT scanner 12, if desired, using any suitable attachment method (not shown) known in the art. Shock wave tube 10 within cylindrical sleeve 14, inner ring 42 and outer ring 44 may be joined to track 78 in any desired manner. For example, one of third axis 56 and forth axis 58 may be movably engaged in track 78.

If track 78 is not mounted to CT scanner 12, it may be supported by first extension 82 and second extension 84 and first linear track 86 and second linear track 88 mounted to the floor. In one example embodiment, first extension 82 and second extension 84 have the capacity to slide along first linear track 86 and second linear track 88. Any suitable track and attachment system known in the art may be used to allow first extension 82 and second extension 84 to slide relative to first linear track 86 and second linear track 88. In other example embodiments, the tracks are attached to the ceiling, the wall or the like.

As previously discussed, the position of shock wave tube 10 along track 78 is controlled by computer 64, which may comprise any suitable computer known in the art. Micro switches are mounted along track 78 in small increments, preferably on the order of about 0.5 mm or less of the arc formed by track 78. In one example embodiment, computer 64 uses the micro switches to sense the location of shock wave tube 10 and to insure that shock wave tube 10 is properly positioned along track 78. For example, when third axles 56 or forth axis 58 moves along track 78, it will contact one of the micro switches. When third axles 56 or forth axis 58 does contact a microswitch, a signal is sent from the contacted micro switch to computer 64 letting computer 64 know the position of shock wave tube 10 along track 78.

In one example embodiment, computer 64 controls the location of shock wave tube 10 along the z-axis (or the long axis of CT scanner 12). In some embodiments, the patient will not be within the gantry when the lithotripsy is performed and the computer must calculate the appropriate location for shock wave tube 10. The position of track 78 is determined, for example, with respect to isocenter of CT scanner 12. Such a calculation can be performed in a number of ways commonly known in the art. In one embodiment, computer 64 runs an algorithm calculating the distance from the point within the gantry where the stone is visualized to the location of the shock wave tube 10 outside the gantry along the z-axis. Cap 72 can be used as a reference for measurement. Such a calculation can work whether shock wave tube 10 is fixed to CT scanner 12 or track 78.

In another example embodiment, CT scanner 12 and its associated technology, including computer 64 and laser 62, are used to guide and monitor the lithotripsy treatment of at least one stone in the kidney or ureter. In using the apparatus described herein, patient 92 is positioned in a prone or supine position on table 80. CT scanner 12 is equipped with a single row (or multiple rows) of X-ray detectors 94 and source 96 of X-rays. One or more sources of X-rays can be used. During each exposure, source 96 and Xray detectors 94 rotate as a single unit around patient 92. At substantially the same time, table 80 is advanced at a constant velocity. Following the completion of each exposure, computer 64 determines the Xray attenuation value at each voxel (volume element) location within the scanned volume. These attenuation values are used to reconstruct individual images (as single slices) as well as to create the volume rendering. The volume rendering is used to determine the relationship of surrounding structures, such as ribs or bowel, to at least one stone 98. From this information, computer 64 determines an optimal shock wave path including the entry site on patient 92.

Based upon the results of volume rendering, the location of at least one stone 98 inside CT scanner 12 is determined along the direction of motion of table 80. Table 80 is then advanced, using any suitable table moving mechanism known in the art, until at least one stone 98 is located in the plane of section at the isocenter of CT scanner 12. Further, imaging of single sections while at least one stone 98 is at this position allows monitoring of stone fragmentation and position during subsequent lithotripsy.

Further, based on the volume rendering, the optimal path to at least one stone 98 is determined and the exact position of the contact point of the shock head to achieve this path is calculated by computer 64. Leaving the patient positioned so that at least one stone 98 remains in the plane of section at isocenter, the shock head is positioned. In one example embodiment, the shock wave path will be displayed as a graphical overlay on the CT volume rendering.

In order to fragment at least one stone 98, shock pulses are delivered by shock wave tube 10. The shock pulses are preferably delivered during short about 5 to about 10 second breathholds, with breathholding done in the same manner as that used to obtain the CT images. Alternatively, using the volume rendering and calculated CT attenuation values during quiet breathing (in a CT fluoroscopy mode), shock wave tube 10 can be triggered to deliver shock waves only when a stone (or stone fragments) are at the focal point of shock wave tube 10.

The apparatus and methods described herein have many advantages when compared to conventional systems. For example, the higher precision of CT stone localization allows the use of a smaller focal area for the shock wave. This reduces energy requirements, minimizes patient discomfort at the entry site, and allows use of a smaller shock tube. CT guidance can reduce the number of shock waves required to fragment stones and thereby reduce the time for fragmentation. Conventional extracorporeal shock wave lithotripsy (ESWL) takes at least 60 minutes per stone including initial patient positioning and stone localization using conventional localization methods, delivery of shock waves and monitoring stone fragmentation. The apparatus and methods described herein reduce the treatment time by up to about 50%, or even about 75%. As such, treatment times can be less than about 30 minutes, less than about 15 minutes, less than about 10 minutes, less than about 5 minutes, or even an entire treatment in seconds.

Conventional ESWL commonly results in tissue injury to surrounding structures as a result of imprecise stone localization and use of a focal area that is typically much larger than stone size. The apparatus and methods described herein will not only reduce surrounding tissue injury due to more precise stone localization, optimization of shock wave path and use of a smaller focal area, but will also allow direct monitoring of the surrounding structures themselves (which is not possible at all with fluoroscopy).

While a helical CT scanner provides optimum imaging for stone localization and treatment monitoring as described herein, these principles can be applied to non-helical CT scanners. Other CT technology, such as multi-slice detectors and sub-second scanners, may be utilized. A multislice detector system, for example, utilizes four or more detector arrays to gather multiple slices of information during a single spiral pass. This greatly enhances the amount of data that can be collected for a patient in the same amount of time as conventional systems. A sub second scanner can run a single pass, for example, a complete 360 degree rotation of the x-ray source and detectors, in less than a second, for example, 0.5 second. A multislice system can be an example of a sub second scanner. These CT technologies can improve the use of the presently described apparatus and methods for guiding and monitoring lithotripsy.

Further, conventional C-arm devices can also be used according to the present description. C-arm devices can be fitted with a shock wave tube, a computer and a guidance system as described herein. The use of a C-arm device can provide, for example, a more portable system. In one example embodiment, a modified C-arm system as described in Linsenmaier et. al. (Radiology, 2002, 224:1 Pages 286-292) can be used according to the present description. Linsenmaier et al. is incorporated herein by reference in its entirety for all that it discloses regarding C-arm devices.

In one example embodiment, the guidance system used in the apparatus and methods described herein can also be used for the guidance of other image directed interventional procedures, such as needle biopsy of tumors and catheter drainage of infected fluid collections anywhere in the body. This simply requires replacing the shock wave tube 10 with a needle-holder in the same gear assembly and ring design.

### Example 1

### Detection and Treatment of a Kidney Stone

A 56 year old male is admitted to the hospital with pain in the lower back. The patient is treated using a CT scanning system as described herein. First, the patient is instructed to lay face down on the CT scanner table. A scan is performed of the two kidneys and a single kidney stone is located within the right kidney. The computer calculates the precise position of the kidney stone and calculates the desired location of the shock wave tube and appropriate duration and energy of the shock wave needed to treat the patient.

The computer moves the shock wave tube into position automatically and an appropriate shock wave dosage is administered to the patient's right kidney at the location of the stone. A subsequent CT scan of the region of the right kidney indicates that the stone has been fragmented and the resulting stones should pass without a problem. The patient returns for a follow-up visit 3 months later and the fragmented stones have passed with little discomfort.

### Example 2

### Detection and Treatment of Renal Colic

A 45 year old female is admitted to the emergency room with a deep pain during urination. The patient is examined using a CT scanning system as described herein. First, the patient is instructed to lay face down on the CT scanner table. A scan is performed of the two kidneys and urethra and a single kidney stone is located within a ureter. The computer calculates the precise position of the kidney stone and calculates the desired location of the shock wave tube and appropriate duration and energy of the shock wave needed to treat the patient.

The computer moves the shock wave tube into position automatically and an appropriate shock wave dosage is administered to the patient's ureter at the location of the stone. A subsequent CT scan of the region of the ureter indicates that the stone has been fragmented and the resulting stones should pass without a problem. The patient returns for a follow-up visit 3 months later and the fragmented stones have passed with little discomfort.

It is apparent that there has been provided herein a precision guidance system for an extracorporeal shock wave which fully satisfies the objects and advantages set forth herein before. While the present disclosure has been described in the context of specific embodiment thereof, other alternatives, modifications, and variations will become apparent to one of skill in the art having read the foregoing description. Accordingly, it is intended to embrace such alternatives, modifications and variations as fall within the broad scope of the appended claims.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Specific embodiments disclosed herein may be further limited in the claims using consisting of or and consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, reference has been made to a printed publication. The above-cited printed publication is incorporated herein by reference in its entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. An apparatus for performing lithotripsy comprising:
a shock wave tube for generating shock wave pulses for fragmenting at least one kidney stone;
a CT scanner comprising; and
a computer for guiding said shock tube;
wherein said computer determines the location of said at least one kidney stone to be treated and obtains a volume rendering to determine a relationship between said at least one kidney stone and at least one surrounding structure; and
wherein said computer further comprises determines a shock wave path including an entry site on a patient using said volume rendering and for controlling movement of said shock wave tube during said lithotripsy.

2. The apparatus according to claim 1, further comprising a track along which said shock wave tube moves.

3. The apparatus according to claim 2, wherein said track is mounted to said CT scanner.

4. The apparatus according to claim 2, wherein said track is movable relative to said CT scanner.

5. The apparatus according to claim 4, wherein said track moves along two linear tracks mounted to a floor.

6. The apparatus according to claim 2, wherein said track is semi-circular.

7. The apparatus according to claim 2, further comprising micro switches along said track for detecting the position of said shock wave tube in said track and for transmitting at least one signal to said computer.

8. The apparatus according to claim 1, wherein said shock wave tube is movable about three orthogonal axes.

9. The apparatus according to claim 8, wherein said shock wave tube is mounted within a cylindrical sleeve having a central axis and a device for moving said shock wave tube relative to said cylindrical sleeve along a first axis parallel to said central axis.

10. The apparatus according to claim 9, wherein said device for moving said shock wave tube along said first axis comprises a gear arrangement and a first motor controlled by said computer.

11. The apparatus according to claim 9, wherein said cylindrical sleeve is mounted inside two concentric rings and wherein said cylindrical sleeve is pivotable about a second axis perpendicular to said first axles and an inner one of said rings is pivotable about a third axis substantially perpendicular to said first axis and said second axis.

12. The apparatus according to claim 11, wherein said cylindrical sleeve is joined to said inner one of said rings by two axles and a second motor controlled by said computer and joined to one of said two axles, said second motor causing said cylindrical sleeve and said shock wave tube to rotate about said second axis.

13. The apparatus according to claim 12, further comprising said inner one of said rings being joined to an outer one of said rings by two inner ring axles and a third motor controlled by said computer and joined to one of said inner ring axles, said third motor causing said inner ring and hence said shock wave tube to rotate about said third axis.

14. The apparatus according to claim 1, further comprising a removable plastic cap fitted over said shock wave tube.

15. The apparatus according to claim 1, wherein said CT scanner is a helical CT scanner.

16. The apparatus according to claim 1, wherein said CT scanner is a non-helical CT scanner.

17. The apparatus according to claim 1, wherein said CT scanner comprises a scanner having multi-slice detectors.

18. The apparatus according to claim 1, wherein said CT scanner comprises a scanner having sub-second scanning time.

19. A method for performing lithotripsy comprising the steps of:
providing a CT scanner having a table and a guidance system;
placing a patient on said table;
performing a volume acquisition and reconstructing at least one image obtained from said volume acquisition to determine a location of at least one kidney stone;
performing a volume rendering to determine a relationship between said at least one kidney stone and at least one surrounding tissue;
using said guidance system to determine a shock wave path including at least one entry site on said patient from said volume rendering;
using said guidance system to position a shock wave tube so as to generate at least one shock wave along said shock wave path; and
generating at least one shock wave using said shock tube so as to fragment said at least one kidney stone.

20. The method according to claim 19, further comprising:
advancing said table until said at least one kidney stone is located in a plane of section at the isocenter of said CT scanner; and
generating single section imaging to monitor fragmentation and position of said at least one kidney stone during subsequent lithotripsy.

21. The method according to claim 19, wherein said shock wave tube positioning step comprises:
providing a track on which said shock wave tube moves; and
using said guidance system to move said shock wave tube along said track to a position for generating said at least one shock wave.

22. The method according to claim 21, wherein said shock wave tube positioning step further comprises using said guidance system to move said shock wave tube about at least one of three orthogonal axes.

23. The method according to claim 19, wherein said shock wave tube positioning step further comprises:
providing said shock wave tube with a plastic rod having a spherical tip located at a maximal focal point of said shock wave tube; and
defining a reference position by positioning said spherical tip at an isocenter of a gantry of said CT scanner.

24. The method according to claim 19, further comprising displaying said shock wave path as a graphical overlay on the volume rendering.

25. The method according to claim 19, wherein the step of generating at least one shock wave comprises generating at least one shock pulse during a breathhold having a duration of about 5 to about 10 seconds.

26. An apparatus for performing lithotripsy comprising:
a shock wave tube for generating shock wave pulses for fragmenting at least one kidney stone;
a removable plastic cap fitted over said shock wave tube;
a CT scanner comprising a computer for guiding said shock tube;
wherein said computer determines the location of said at least one kidney stone to be treated and obtains a volume rendering to determine a relationship between said at least one kidney stone and at least one surrounding structure; and
wherein said computer further determines a shock wave path including an entry site on a patient using said volume rendering and for controlling movement of said shock wave tube during said lithotripsy.

27. The apparatus according to claim 26, further comprising a rod extending from said plastic cap along an axis of said shock wave tube.

28. The apparatus according to claim 27, wherein said rod has no x-ray attenuation.

29. The apparatus according to claim 27, wherein said rod comprises a sphere of radioopaque epoxy resin at its tip.

30. The apparatus according to claim 29, wherein said sphere has a diameter less than about 1.0 mm.

31. The apparatus according to claim 29, wherein said rod has a length such that said sphere is positioned at the maximal focal point of the shock wave tube.
